(19) United States
(12) Patent Application Publication
(10) Pub. No.: US 2019/0359001 A1
(43) Pub. Date: Nov. 28, 2019

(54) POLYAMIDE CORD FOR USE AS A CARCASS REINFORCEMENT, PNEUMATIC VEHICLE TIRE COMPRISING ONE OR MORE POLYAMIDE CORDS AND METHOD FOR PRODUCING ONE OR POLYAMIDE CORDS, METHOD FOR PRODUCING A RUBBERIZED REINFORCING PLY AND METHOD FOR PRODUCING A MOTOR VEHICLE TIRE

(71) Applicant: Continental Reifen Deutschland GmbH, Hannover (DE)

(72) Inventors: Tiago Moura, Hannover (DE); Ralf Krieger, Hannover (DE); Matthias-Stephan Mueller, Garbsen (DE); Carsten Minx, Neustadt (DE); Andreas Emde, Burgwedel (DE)

(73) Assignee: Continental Reifen Deutschland GmbH, Hannover (DE)

(21) Appl. No.: 16/482,403

(22) PCT Filed: Dec. 19, 2017
(86) PCT No.: PCT/EP2017/083413

§ 371 Date: Jul. 31, 2019

(30) Foreign Application Priority Data
Feb. 1, 2017 (DE) 10 2017 201 631.0

(51) Int. Cl. B60C 9/00; B29D 30/38; B29B 15/12; D02G 3/48; D06M 15/693; B60C 9/08

(52) U.S. Cl. CPC B60C 9/0042; B29D 30/38; B29B 15/125; B29K 2277/00; D06M 15/693; B60C 9/08; B29D 2030/383; D02G 3/48

(57) ABSTRACT

The invention relates to a polyamide cord for use as carcass strength member in a pneumatic vehicle tire, wherein the polyamide cord has a residual shrinkage in the range from 0% to 2% and a shrinkage at 180° C. in the range from 0% to 4.5%, where the residual shrinkage of the polyamide cord and the shrinkage at 180° C. of the polyamide cord are determined to ASTM D 855. The invention also relates to a pneumatic vehicle tire comprising one or more polyamide cords and to a process for producing one or more polyamide cords, to a process for producing a rubberized reinforcement ply and to a process for producing a pneumatic vehicle tire.

The invention relates to a polyamide cord for use as carcass strength member in a pneumatic vehicle tire and to a pneumatic vehicle tire comprising one or more polyamide cords.

The invention also relates to a process for producing one or more polyamide cords, to a process for producing a rubberized reinforcement ply and to a process for producing a pneumatic vehicle tire.

Strength members for reinforcement of various elastomeric products, for example a reinforcement ply in a pneumatic vehicle tire, are sufficiently well known. In the production of the pneumatic vehicle tire, they can make a crucial contribution to various properties of the resulting pneumatic vehicle tire.

Pneumatic vehicle tires supplied on the market are subject to high quality demands, especially including the demands on the dimensions of the pneumatic vehicle tires. Therefore, in the industrial scale manufacture of pneumatic vehicle tires, it is only permissible for few, if any, production faults that lead to deviations in the required tire dimensions to occur. The unwanted deviations include imbalances or other nonuniformities in the pneumatic vehicle tires produced. By reduction in such deviations, it is possible to increase the proportion of the pneumatic vehicle tires in tire production that meet customer demands. This can increase raw material utilization in the production process and hence reduce environmental pollution.

Various strength members for reinforcement plies are known in the prior art:

DE 102012108523 A1 discloses a “Reinforcement cord for elastomeric products, especially for a pneumatic vehicle tire, and pneumatic vehicle tire” (title). It is disclosed that a stable reinforcement cord is obtained when “it consists of at least one yarn of PEF made entirely or at least partly from biomasses and/or renewable raw materials and at least one yarn of rayon” (cf. paragraph [0039]).

Furthermore, document U.S. Pat. No. 3,614,864 discloses “two-ply polyamide tire cord” (title). Also disclosed therein are various twist factors (see table in column 4).

In addition, the document having publication number US 2011/0056607 A1 discloses a “Heavy duty pneumatic tire” (title).

Document EP 2394822 A1 discloses, inter alia, “Tires having a zigzag belt reinforcing structure, especially for aircraft tires with reduced weight” (title). A radial carcass ply cord fiber of nylon is disclosed (cf. paragraph [0017]).

It is an object of the present invention to provide a polyamide cord for use as carcass strength member in a pneumatic vehicle tire, which, by virtue of its use as carcass strength member in a pneumatic vehicle tire, has the effect that the resulting pneumatic vehicle tire pollutes the environment to a lesser degree than a pneumatic vehicle tire known from the prior art. At the same time, it was a further object of the present invention to provide a polyamide cord for use in a pneumatic vehicle tire which increases the lifetime of the pneumatic vehicle tire comprising the polyamide cord compared to the lifetime of a pneumatic vehicle tire known from the prior art.

This object is achieved in accordance with the invention in relation to the polyamide cord in that

the polyamide cord has a residual shrinkage in the range from 0% to 2% and a shrinkage at 180° C. in the range from 0% to 4.5%, where the residual shrinkage of the polyamide cord and the shrinkage at 180° C. of the polyamide cord are determined to ASTM D 855.

The above object is achieved in accordance with the invention by the above-described polyamide cord in that the residual shrinkage and shrinkage at 180° C. of the polyamide cord is adjusted to the respective range described above. It has been found that, surprisingly, pneumatic vehicle tires that have been produced with the aid of the polyamide cord of the invention not only have particularly high tire uniformity compared to the pneumatic vehicle tires known from the prior art, but also have tire uniformity that meets customer demands more frequently than pneumatic vehicle tires known from the prior art. In accordance with illustrative customer demands, the deviation of the ascertained geometric center of the tread contour of the motor vehicle tire produced may differ only by 1.25 mm from the center of the bead circle of the radial first harmonic. In production processes known in the prior art, the proportion of motor vehicle tires produced that do not meet this criterion is between 10% and 30% of the totality of the pneumatic vehicle tires produced. This proportion of pneumatic vehicle tires therefore cannot be sold to a sensible use and is therefore frequently discarded unutilized. By virtue of the use of a polyamide cord of the invention as described above, more than 90% of the pneumatic vehicle tires produced have deviation of the ascertained geometric center of the tread contour of the pneumatic vehicle tire produced from the center of the bead circle of the radial first harmonic of less than 1.25 mm. Thus, the production costs of the resulting pneumatic vehicle tire of the invention and the resultant environmental pollution are reduced by the production. Furthermore, pneumatic vehicle tires of the invention, by virtue of their higher uniformity, also have lower fuel consumption than pneumatic vehicle tires known in the art. This additionally leads to an additional reduction in environmental pollution by pneumatic vehicle tires of the invention.

It is a further advantage of the invention that the adjustment of the residual shrinkage and shrinkage at 180° C. to the above-defined ranges results in a polyamide cord of the invention that additionally has higher elongation at break than polyamide cords known in the prior art. Therefore, a polyamide cord of the invention is especially advantageous for vehicles with heavy loads, for example for pneumatic van, truck or agricultural tires.

It is a further advantage of the invention that a pneumatic vehicle tire comprising a polyamide cord of the invention, owing to the above-described optimized shrinkage characteristics, has reduced flat-spotting since the varying environmental conditions that occur in a pneumatic vehicle tire affect a polyamide cord of the invention to a lesser degree than pneumatic vehicle tires with cords known in the art. This also leads to prolonged lifetime of a pneumatic vehicle tire with a polyamide cord of the invention as carcass strength member.

The present invention further provides a polyamide cord as described above in a rubberized reinforcement ply of a pneumatic vehicle tire, and a polyamide cord as described above in a carcass ply of a pneumatic vehicle tire. This is also applicable to all the aspects of the present invention described hereinafter.

Preference is also given to a polyamide cord as described above, characterized in that the polyamide cord has a twist factor in the range from 170 to 250, preferably in the range from 170 to 230, more preferably in the range from 190 to 210, most preferably in the range from 200 to 210.

In the course of in-house studies of polyamide cords of the invention with different twist factors, it has been found that a distinctly longer lifetime of the pneumatic vehicle tires can be achieved with this polyamide cord of the invention by comparison with pneumatic vehicle tires in which the twist factor is outside the ranges defined above. Moreover, surprisingly, only a slight increase in residual shrinkage and shrinkage at 180° C. has been found. This is surprising because, in the case of polyamide cords known in the art with a twist factor within the aforementioned ranges, residual shrinkage is always higher than 3% and shrinkage at 180° C. is always higher than 6%, and hence pneumatic vehicle tires having these polyamide cords have lower tire uniformity. It was therefore not to be expected that a polyamide cord with a twist factor within the aforementioned ranges and simultaneously with a residual shrinkage and shrinkage at 180° C. as described above can be produced.

The polyamide cord of the invention described above as preferred therefore has the effect, when used as carcass strength member in a pneumatic vehicle tire, that the pneumatic vehicle tire of the invention, by comparison with a pneumatic vehicle tire known in the art, has a longer lifetime and simultaneously, in spite of the high twist factor, no significantly higher residual shrinkage or shrinkage at 180° C. Both the prolonged lifetime and the elevated tire uniformity lead, as described further up, to lower environmental pollution by the resulting pneumatic vehicle tire of the invention.

In the context of the present invention, the twist factor is defined as follows:

$${T}_{F} = {N}_{yarn twist} \cdot \sqrt[2]{\frac{{N}_{yarns} \cdot {M}_{linear yarn density}}{{k}_{dtex}}} \qquad ( equation 1 )$$

where N_{yarn twist}=number of twists of the yarns around one another per meter of cord [tpm],
N_{yarns}=number of yarns in the cord,
M_{linear yarn density}=mass of 10 000 meters of yarn [dtex]
and
the constant k_{dtex}=10 000.

The person skilled in the art knows how the variables of equation 1 (i.e. N_{yarn twist}, N_{yarns} and M_{linear yarn density}) can be determined for any polyamide cord.

Preference is given to a polyamide cord as described above, characterized in that the polyamide cord has a total linear density in the range from 940 dtex to 6000 dtex, preferably in the range from 1500 dtex to 4000 dtex, more preferably in the range from 2500 dtex to 4000 dtex, most preferably in the range from 3000 dtex to 4000 dtex.

In the context of the present invention, the total linear density of a cord is the mathematical product of the number of yarns twisted to give the cord and the linear yarn density of the yarns twisted to give the cord (normally reported in dtex).

It is an advantage of the above-described aspect of the invention that the resulting pneumatic vehicle tires comprising a preferred polyamide cord having a total linear density as described above as carcass strength member have higher tire uniformity than pneumatic vehicle tires in which the polyamide cord has a different total linear density. At the same time, yarn consumption is optimized. Furthermore, preferred polyamide cords of the invention, as described above, have better elongation at break and tensile strength than cords known from the prior art.

Preference is given to a polyamide cord as described above, characterized in that the polyamide cord consists of two, three, four or more than four twisted multifilament yarns, where each of the multifilament yarns preferably has a linear yarn density in the range from 1000 dtex to 3000 dtex, more preferably in the range from 1400 dtex to 2000 dtex, most preferably in the range from 1600 dtex to 2000 dtex.

In the context of the present invention, the linear yarn density of a multifilament yarn is the mass of a particular multifilament yarn section relative to its length (reported in dtex).

It is an advantage of the above-described aspect of the invention that the resulting pneumatic vehicle tires comprising a preferred polyamide cord having multifilament yarns as described above as carcass strength member have higher tire uniformity than pneumatic vehicle tires in which the polyamide cord has a different total linear density. At the same time, yarn consumption is optimized.

A polyamide cord of the invention as described above (or as described above as preferred) may advantageously consist of two or more twisted multifilament yarns, where the individual multifilaments of the two or more twisted multifilament yarns have been twisted in S direction to give the respective multifilament yarn and two or more of the twisted multifilament yarns have been twisted in Z direction to give the polyamide cord. In some cases, alternatively, a polyamide cord of the invention as described above (or as described above as preferred) may advantageously consist of two or more twisted multifilament yarns, where the individual multifilament of the two or more twisted multifilament yarns have been twisted in Z direction to give the respective multifilament yarn and two or more of the twisted multifilament yarns have been twisted in S direction to give the polyamide cord.

Preference is also given to a polyamide cord as described above (or as described above as preferred), characterized in that

the polyamide cord has an elongation at break in the region of greater than 20%, preferably in the range from 21% to 30%, more preferably in the range from 23% to 26%, and/or
the polyamide cord has a tensile strength in the range from 200 N to 400 N, preferably in the range from 220 N to 300 N, more preferably in the range from 250 N to 290 N.

It is an advantage of the above-described aspect of the invention that the resulting pneumatic vehicle tires having a preferred polyamide cord of the invention as described above have an even longer lifetime than pneumatic vehicle tires comprising a polyamide cord having lower elongation at break or tensile strength as carcass strength member.

Preference is also given to a polyamide cord as described above (or as described above as preferred), characterized in that

the polyamide cord has a residual shrinkage in the range from 0.5% to 2%, preferably in
the range from 0.8% to 2%, more preferably in the range from 0.8% to 1.5%, most preferably in the range from 0.9% to 1.1%,
and/or
the polyamide cord has a shrinkage at 180° C. in the range from 0.5% to 4.5%, preferably in the range from 1% to 4.5%, more preferably in the range from 2% to 4.5%, most preferably in the range from 3% to 4%.

It is an advantage of the above-described aspect of the invention that the resulting pneumatic vehicle tires comprising a preferred polyamide cord of the invention as described above as carcass strength member have even greater tire uniformity compared to pneumatic vehicle tires comprising a polyamide cord having higher residual shrinkage and/or shrinkage at 180° C. as carcass strength member.

Preference is also given to a polyamide cord as described above, characterized in that the polyamide cord has PA6 or PA6.6 as main constituent, preferably consists of PA6 or PA6.6.

It is an advantage of the above-described aspect of the invention that PA6.6 cords, by comparison with PE cords, can be better processed in the production process for the PA6.6 cord and, owing to the advantageous material properties of the PA6.6 cord, better physical properties of the resulting pneumatic vehicle tire can be achieved. This is true, for example, of carcass plies in pneumatic agricultural tires in which polyamide cords are used in place of polyethylene cords since polyamide cords have higher elongation at break and higher tensile strength and hence can be subjected to higher stress.

For the pneumatic vehicle tires of the invention having a PA6.6 cord of the invention as described above, this results in even greater tire uniformity than in the case of pneumatic vehicle tires comprising a polyamide cord made of other materials as carcass strength member.

Most preferably, a polyamide cord of the invention is characterized in that the polyamide cord
has a total linear density of 2800 dtex,
consists of two twisted multifilament yarns, each of the multifilament yarns having a linear yarn density of 1400,
has a twist factor in the range from 190 to 210,
has a residual shrinkage of 1.1%,
has a shrinkage at 180° C. of 3.9%
and
consists of PA6.6.

Above-described polyamide cords of the invention can be used for production of pneumatic vehicle tires, where the pneumatic vehicle tires produced have particularly advantageous properties compared to pneumatic vehicle tires known from the prior art. Such advantageous properties include, for example, particularly high tire uniformity and/or a longer lifetime compared to pneumatic vehicle tires of the invention that do not comprise the very particularly preferred polyamide cord as described above.

Even more preferred than the above-described very particularly preferred polyamide cord is a polyamide cord of the invention characterized in that the polyamide cord
has a total linear density of 3760 dtex,
consists of two twisted multifilament yarns, each of the multifilament yarns having a linear yarn density of 1880,
has a twist factor of 190 to 210,
has a residual shrinkage of 0.9%,
has a shrinkage at 180° C. of 3.8%
and
consists of PA6.6.

Above-described polyamide cords of the invention can be used for production of pneumatic vehicle tires, where the pneumatic vehicle tires produced have particularly advantageous properties compared to pneumatic vehicle tires known from the prior art. Such advantageous properties include, for example, particularly high tire uniformity and/or a longer lifetime compared to pneumatic vehicle tires of the invention that do not comprise one of the very particularly preferred polyamide cords as described above.

The invention also relates to a rubberized reinforcement ply for a pneumatic vehicle tire comprising a polyamide cord as described above (or as described above as preferred or as described above as particularly preferred), characterized in that the rubberized reinforcement ply is preferably a carcass ply of a pneumatic vehicle tire.

The above-described advantageous aspects of a polyamide cord of the invention are also applicable to all aspects of a rubberized reinforcement ply described hereinafter and the advantageous aspects of rubberized reinforcement plies of the invention described hereinafter, and the uses thereof are correspondingly applicable to all aspects of an above-described polyamide cord of the invention.

The invention also relates to a pneumatic vehicle tire comprising a rubberized reinforcement ply as described above, characterized in that the rubberized reinforcement ply is preferably a carcass ply.

The invention also relates to a pneumatic vehicle tire comprising one or more polyamide cords as described above (or as described above as preferred), characterized in that the one or more polyamide cords are preferably present in a carcass strength member.

The above-described advantageous aspects of a polyamide cord of the invention or of a rubberized reinforcement ply of the invention are also applicable to all aspects of a pneumatic vehicle tire described hereinafter, and the advantageous aspects of pneumatic vehicle tires of the invention described hereinafter are correspondingly applicable to all aspects of an above-described polyamide cord of the invention and a rubberized reinforcement ply of the invention.

Preference is given to a pneumatic vehicle tire of the invention as described above, characterized in that the pneumatic vehicle tire

is a pneumatic car, van, truck or agricultural tire, preferably a pneumatic van, truck or agricultural vehicle tire, more preferably a pneumatic truck or agricultural tire, most preferably a pneumatic agricultural tire,
where the pneumatic vehicle tire is especially a pneumatic agricultural tire having a wheel rim size in the range from 16 inches (about 40.64 cm) to 52 inches (about 132.08 cm), preferably in the range from 24 inches (about 60.96 cm) to 48 inches (about 121.92 cm).

It is an advantage of the above-described aspect of the invention that, especially in the case of heavy vehicles, large gravitational forces act on the pneumatic vehicle tires used and hence are more likely to lead to deformation of the pneumatic vehicle tire, especially to flat-spotting. Moreover, agricultural vehicles often do not have any shock absorbers on the rear axle, as a result of which any tire nonuniformity in the pneumatic agricultural tire has an adverse effect on the vehicle frame. Therefore, the use of polyamide cords of the invention in an above-described preferred pneumatic vehicle tire of the invention is particularly advantageous, especially use in a pneumatic vehicle tire on a vehicle having a wheel rim size of 24 inches (about 60.96 cm) to 48 inches (about 121.92 cm). Vehicles having the above-described wheel rim sizes are frequently used for transport functions where the temperature level of 50° C. is exceeded, above which the polyamide shrinkage process sets in.

Particular preference is given to a pneumatic vehicle tire as described above (or as described above as preferred), characterized in that the pneumatic vehicle tire
comprises a radial carcass having 1 to 6 carcass plies, preferably a radial carcass having 2 to 3 carcass plies.

It is an advantage of the above-described aspect of the invention that, in the case of pneumatic agricultural tires of the invention, 6 carcass plies in the radial carcass are sufficient to assure a long lifetime of the pneumatic agricultural tires in spite of the weight stress which is customary in pneumatic agricultural tires. It is a further advantage of the above-described aspect of the invention that, by virtue of the use of a polyamide cord of the invention in a pneumatic agricultural tire, 2 to 3 carcass plies in the radial carcass are sufficient to assure a long lifetime of the pneumatic agricultural tires in the case of pneumatic agricultural tires customary weight stress and in order at the same time to assure even higher tire uniformity than in the case of pneumatic agricultural tires having more than 3 carcass plies.

Very particular preference is given to a pneumatic vehicle tire as described above as particularly preferred, characterized in that the pneumatic vehicle tire additionally comprises
a profiled tread,
a one-, two-, three-, four-, five-, six-, seven- or eight-ply belt, preferably with a two-, three-, four-, five- or six-ply belt,
and/or
a single- or multi-ply belt bandage that covers the belt, preferably with strength members running in circumferential direction of the pneumatic vehicle tire.

Very particular preference is given especially to a pneumatic vehicle tire as described above as very particularly preferred, characterized in that the pneumatic vehicle tire, preferably a pneumatic agricultural tire, has
a radial carcass having 2 to 3 carcass plies,
a two-, three-, four-, five- or six-ply belt
and
a wheel rim size in the range from 24 inches (about 60.96 cm) to 48 inches (about 121.92 cm).

The invention also relates to a process for producing one or more polyamide cords, preferably one or more polyamide cords as described above (or as described above as preferred),

wherein the process comprises at least the following process steps in the following sequence:
a. dipping one or more textile strength members into at least a first dip bath containing at least one latex and/or at least one resin, preferably in an aqueous mixture, and
b. then heat treating the one or more dipped strength members within a temperature range from 120 to 260° C., preferably within a temperature range from 140 to 240° C., more preferably within a temperature range from 160 to 220° C., and simultaneously stretching the one or more strength members, such that, over the entire process, the one or more strength members have been subjected to a total extension in the range from 0% to 6%, preferably in the range from 0.5% to 6%, more preferably in the range from 0.8% to 4%, most preferably in the range from 1% to 1.2%.
c. further processing the one or more heat-treated strength members so as to form one or more polyamide cords, preferably one or more polyamide cords as described above (or as described above as preferred).

The above-described advantageous aspects of a polyamide cord of the invention, of a rubberized reinforcement ply or of a pneumatic vehicle tire are also applicable to all aspects of a process described below for producing one or more polyamide cords, and the advantageous aspects described below of processes according to the invention for producing one or more polyamide cords are correspondingly applicable to all aspects of an above-described polyamide cord of the invention, of a rubberized reinforcement ply or of a pneumatic vehicle tire.

The invention also relates to a polyamide cord produced or producible by a process for production as described above (or as described above as preferred).

Step b. in the above-described process for producing one or more polyamide cords is preferably executed as follows:

b1. then drying the one or more dipped strength members within a temperature range from 140 to 160° C.
and
b2. then heat treating the one or more dried strength members in a heat-stretching zone between 210° C. and 260° C.,
wherein, during steps b1. and b2., the one or more strength members are stretched in such a way that, over the entire process, the one or more strength members have been subjected to a total extension in the range from 0% to 6%, preferably in the range from 0.5% to 6%, more preferably in the range from 0.8% to 4%, most preferably in the range from 1% to 1.2%.

It is known in the prior art that strength members, prior to rubberization, can be activated for an improvement in the material properties of the textile strength members, using various dip baths, typically what are called RFL (resorcinol-formaldehyde latex) dips, by means of which the strength members are dipped. This is also true of polyamide cords of the invention.

According to the invention, the textile strength members in above-described process step a) are preferably treated by dipping in at least one first dip bath, where the dip bath contains at least one latex.

The textile strength members are still unrubberized before and after this process step. The dip bath is preferably an aqueous mixture containing, as well as water and a latex, at least one resin, preferably an RF resin. In addition, ammonia and formaldehyde may also be present in the first dip bath. The latex here is preferably a vinyl-pyridine latex or polymerized chloroprene, more preferably a vinylpyridine-styrene-butadiene terpolymer as vinyl-pyridine latex.

The strength member is dipped into the first dip bath in a known manner. Such a treatment step is also referred to as pre-dip.

Thereafter, there may optionally follow a drying operation on the one or more textile strength members in a drying zone, and then the textile strength members are subjected to a heat treatment in a heat-stretching zone, in which the dipped textile strength members are stretched in various treatment phases. The sum total of the extensions in these individual treatment phases and in the drying zone is what is called the total extension. Thereafter, further processing of the stretched textile strength members can take place, for example a normalization zone, to give polyamide cords.

The operation composed at least of dipping in a first dip bath, heat treatment and stretching of the polyamide cord, in the context of the present invention, is a pretreatment of the polyamide cord. In the pretreatments known from the prior art, the pretreated cords normally undergo comparatively high total extension. Moreover, in the prior art, specific temperature programs are utilized in the pretreatment of the cords in order to exactly adjust the properties of the resulting cords.

It has now been found that, surprisingly, the reduction in the total extension in the pretreatment of a polyamide cord produced in accordance with the invention has a significant effect on its residual shrinkage and shrinkage at 180° C. The above-described reduction in total extension during the pretreatment of the polyamide cords results in polyamide cords having particularly low shrinkage at 180° C. and particularly low residual shrinkage compared to cords known in the art.

Subsequent incorporation of these polyamide cords produced in accordance with the invention in a pneumatic vehicle tire results in a pneumatic vehicle tire of the invention having higher tire uniformity than in the case of pneumatic vehicle tires with polyamide cords known from the art. Therefore, a greater proportion of pneumatic vehicle tires produced with polyamide cords produced in accordance with the invention meets the quality demands required in the industry than pneumatic vehicle tires with polyamide cords that have been produced by methods known from the prior art. This increases raw material consumption in the production of the pneumatic vehicle tires. At the same time, a motor vehicle having the more uniform pneumatic vehicle tires also consumes less fuel. Both reduce environmental pollution.

The invention also relates to a process for producing
a rubberized reinforcement ply as described above, preferably a rubberized reinforcement ply comprising one or more polyamide cords as described above (or as described above as preferred)
   or
a rubberized reinforcement ply, where the process comprises process steps a. to c. as defined above in a process for producing one or more polyamide cords, preferably as described above or as described above as preferred, and then comprises the following process step:
   d. rubberizing the one or more polyamide cords, preferably as described above or as described above as preferred, with a rubberization mixture and further processing so as to form a rubberized reinforcement ply.

There follows a detailed elucidation of the constituents of the rubberization mixture. All embodiments are also applicable to a polyamide cord of the invention that has been produced by the process of the invention, and to a pneumatic vehicle tire of the invention that includes the polyamide cord of the invention in at least one tire component. The constituents of the rubberization mixture, especially the rubbers, may be in chemically altered form in the vulcanized tire.

The rubberizing mixture may comprise further activators and/or agents for the incorporation of fillers, especially carbon black. The latter may, for example, be the compound S-(3-aminopropyl)thiosulfuric acid disclosed, for example, in EP 2589619 A1, and/or metal salts thereof, which gives rise to very good physical properties of the rubberizing mixture especially in combination with at least one carbon black as filler.

It is also possible for 0 to 70 phr, preferably 0.1 to 60 phr, of at least one plasticizer to be present in the rubberizing mixture. Such plasticizers include all plasticizers known in the art, such as aromatic, naphthenic or paraffinic mineral oil plasticizers, for example MES (mild extraction solvate) or TDAE (treated distillate aromatic extract), or rubber-to-liquid oils (RTL) or biomass-to-liquid oils (BTL; as disclosed in DE 10 2008 037714 A1) or oils based on renewable raw materials (for example rapeseed oil, terpene oils (e.g. orange oils)) or factices or plasticizer resins or liquid polymers (such as liquid BR), the average molecular weight of which (determined by GPC=gel permeation chromatography, using a method based on BS ISO 11344:2004) is in the range from 500 to 20 000 g/mol. If liquid polymers are used as plasticizers in the rubberizing mixture, these are not counted as rubber in the calculation of the composition of the polymer matrix (phr calculation). When mineral oil is used, it is preferably selected from the group consisting of DAE (distilled aromatic extracts) and/or RAE (residual aromatic extracts) and/or TDAE (treated distilled aromatic extracts) and/or MES (mild extracted solvents) and/or naphthenic oils.

Furthermore, the rubberizing mixture may comprise standard additives in customary proportions by weight. These additives include
A) aging stabilizers, for example N-phenyl-N′-(1,3-dimethylbutyl)-p-phenylenediamine (6PPD), N,N′-diphenyl-p-phenylenediamine (DPPD), N,N′-ditolyl-p-phenylenediamine (DTPD), N-isopropyl-N′-phenyl-p-phenylenediamine (IPPD), 2,2,4-trimethyl-1,2-dihydroquinoline (TMQ) and other substances as known, for example, from J. Schnetger, Lexikon der Kautschuktechnik [Lexicon of Rubber Technology], 2nd edition, Hüthig Buch Verlag, Heidelberg, 1991, p. 42-48,
B) activators, for example zinc oxide and fatty acids (e.g. stearic acid),
C) waxes,
D) resins, especially tackifying resins that are not plasticizer resins,
E) methylene acceptors, such as resorcinol and resorcinol equivalents, and/or methylene donors/formaldehyde donors, for example hexamethoxymethylmelamine (HMMM) and/or hexamethylenetetramine (HMT).
F) masticating aids, for example 2,2′-dibenzamidodiphenyl disulfide (DBD) and
G) processing aids, for example fatty acid salts, for example zinc soaps, and fatty acid esters and derivatives thereof, for example PEG carboxylates.

The production of the rubberization mixture and the employment thereof on the polyamide cord of the invention or a polyamide cord produced by the process described above are effected in a conventional manner.

After the rubberization of the polyamide cord and processing of the rubberized polyamide cord in a tire blank, preference is given to conducting a vulcanization in the presence of sulfur and/or sulfur donors, where some sulfur donors can at the same time act as vulcanization accelerators. In addition, the vulcanization can be conducted in the presence of vulcanization-influencing substances such as vulcanization accelerators, vulcanization retardants and vulcanization activators in customary amounts, in order to control the time required and/or the temperature required in the vulcanization and to improve the vulcanization properties.

The above-described advantageous aspects of a polyamide cord of the invention, of a rubberized reinforcement ply of the invention, of a pneumatic vehicle tire of the invention or of a process of the invention for producing one or more polyamide cords are also applicable to all aspects of a process described below for producing a rubberized reinforcement ply, and the advantageous aspects described below of processes of the invention for producing a rubberized reinforcement ply are correspondingly applicable to all aspects of an above-described polyamide cord of the invention, of a rubberized reinforcement ply of the invention, of a motor vehicle tire of the invention or of a process of the invention for producing one or more polyamide cords.

Preference is given to a process of the invention as described above,

characterized in that the rubberization mixture
contains at least one diene rubber selected from the group consisting of natural polyisoprene and/or synthetic polyisoprene and/or butadiene rubber and/or styrene-butadiene rubber,
and
20 to 90 phr of at least one filler selected from the group consisting of carbon black and/or silica.

The invention also relates to a process for producing
a pneumatic vehicle tire as described above (or as described above as preferred or as described above as particularly preferred)
   or
a pneumatic vehicle tire comprising one or more polyamide cords produced or producible by a process for producing one or more polyamide cords as described above (or as described above as preferred or as described above as particularly preferred)
   or
a pneumatic vehicle tire, wherein the process comprises process steps a. to d. as defined above and then the following process steps:
   e. incorporating the rubberized reinforcement ply into a tire blank and further processing the tire blank to give a pneumatic vehicle tire.

The above-described advantageous aspects of a polyamide cord of the invention, of a rubberized reinforcement ply of the invention, of a pneumatic vehicle tire of the invention, of a process of the invention for producing one or more polyamide cords or of a process of the invention for producing a rubberized reinforcement ply are also applicable to all aspects of a process described below for producing a pneumatic vehicle tire, and the advantageous aspects described below of processes of the invention for producing a pneumatic vehicle tire are correspondingly applicable to all aspects of an above-described polyamide cord of the invention, of a rubberized reinforcement ply of the invention, of a motor vehicle tire of the invention, of a process of the invention for producing one or more polyamide cords or of a process of the invention for producing a rubberized reinforcement ply.

The above-described advantageous aspects of a polyamide cord of the invention, of a rubberized reinforcement ply of the invention, of a motor vehicle tire of the invention, of a process of the invention for producing a rubberized reinforcement ply, of a process of the invention for producing a motor vehicle tire or of a process of the invention for producing one or more polyamide cords are also applicable to all aspects of the uses described below.

The invention also relates to the use of a rubberized reinforcement ply as described above as carcass ply of a motor vehicle tire.

The invention also relates to the use of a motor vehicle tire as described above (or as described above as preferred or particularly preferred) as a pneumatic car, van, truck or agricultural tire, preferably as a pneumatic van, truck or agricultural tire, more preferably as a pneumatic truck or agricultural tire, most preferably as a pneumatic agricultural tire.

The invention is now to be elucidated in detail with reference to the examples which follow.

Test Methods:
1. Elongation at break
   The results were ascertained in accordance with the DIN 53504 method.
2. Tensile strength
   The results were ascertained in accordance with the DIN 53504 method.
3. Disk fatigue test
   The results were ascertained in accordance with the ASTM D 6588 method on a suitable test instrument, for example from the manufacturers Viscosuisse AG or Anlagen- and Maschinenbau W. In the measurement for the data reported in table 1, the specimens were extended in 15 000 000 cycles from a minimum extension of 5.1% up to a maximum extension of 9.9%. In the measurement for the data reported in table 2, the specimens were extended in 15 000 000 cycles from a minimum extension of 1.4% up to a maximum extension of 13.5%.
4. Tire uniformity
   The results were ascertained with the aid of the radial runout method.
   Once the pneumatic vehicle tire has been applied to a wheel rim, this involves placing it under pressure (2 bar) and rotating it about the axis of rotation of the wheel rim. In the course of rotation, by measuring the surface protrusions in the center of the tread of the pneumatic vehicle tire, the exact circumferential shape of the tire is measured. This involves examining the profile of the outer contour by means of an FFT analysis (Fourier transformation analysis). The ascertained magnitude of the first harmonic is called “1st harmonic”. With the aid of the first harmonic, the geometric center of the circumferential shape of the tire thus measured is then ascertained and the deviation of the geometric center ascertained from the axis of rotation of the wheel rim is calculated. This deviation gives a quantitative statement as to the tire uniformity.

### Production of the Various Polyamide Cords and Pneumatic Vehicle Tires

### EXAMPLE 1 (COMPARATIVE EXPERIMENT V1): NONINVENTIVE POLYAMIDE CORD FOR USE AS CARCASS STRENGTH MEMBER WITH A TOTAL LINEAR DENSITY OF 2880 DTEX

Cords produced from two PA6.6 yarns in each case having a total linear density of 2880 dtex (1440×2) with a yarn twist of 290 were dipped by means of a pre-dip containing 46.49 parts by weight of water, 45.67 parts by weight of vinyl-pyridine latex and 2.25 parts by weight of ammonia, 3.14 parts by weight of Penacolite resin (commercially available aqueous solution with 75% by weight of Penacolite resin as resorcinol-formalin reaction product), 0.17 part by weight of a commercially available aqueous NaOH solution (50% by weight of NaOH) and 2.28 parts by weight of formaldehyde (commercially available 37% by weight solution). Subsequently, the PA6.6 cords were dried between 140° C. and 160° C. for 30 to 120 seconds and then heat-treated in a heat-stretching zone between 210° C. and 260° C. In the normalization zone, the heat-stretched PA6.6 cords were cooled down to room temperature. The total extension in the pretreatment was 7%.

### EXAMPLE 2 (EXPERIMENTS E1 TO E4): INVENTIVE POLYAMIDE CORD FOR USE AS CARCASS STRENGTH MEMBER WITH A TOTAL LINEAR DENSITY OF 2880 DTEX

Cords produced from two PA6.6 yarns in each case having a total linear density of 2880 dtex (1440×2) with various yarn twists (see table 1) were dipped by means of a pre-dip containing 46.49 parts by weight of water, 45.67 parts by weight of vinyl-pyridine latex and 2.25 parts by weight of ammonia, 3.14 parts by weight of Penacolite resin (commercially available aqueous solution with 75% by weight of Penacolite resin as resorcinol-formalin reaction product), 0.17 part by weight of a commercially available aqueous NaOH solution (50% by weight of NaOH) and 2.28 parts by weight of formaldehyde (commercially available 37% by weight solution). Subsequently, the PA6.6 cords were dried between 140° C. and 160° C. for 30 to 120 seconds and then heat-treated in a heat-stretching zone between 210° C. and 260° C. In the normalization zone, the heat-stretched PA6.6 cords were cooled down to room temperature. The total extension in the pretreatment was 1.2%.

### EXAMPLE 3 (EXPERIMENT E5): INVENTIVE POLYAMIDE CORD FOR USE AS CARCASS STRENGTH MEMBER WITH A TOTAL LINEAR DENSITY OF 3760 DTEX

Cords produced from two PA6.6 yarns in each case having a total linear density of 3760 dtex (1880×2) with a yarn twist of 335 tpm were dipped by means of a pre-dip containing 46.49 parts by weight of water, 45.67 parts by weight of vinyl-pyridine latex and 2.25 parts by weight of ammonia, 3.14 parts by weight of Penacolite resin (commercially available aqueous solution with 75% by weight of Penacolite resin as resorcinol-formalin reaction product), 0.17 part by weight of a commercially available aqueous NaOH solution (50% by weight of NaOH) and 2.28 parts by weight of formaldehyde (commercially available 37% by weight solution). Subsequently, the PA6.6 cords were dried between 140° C. and 160° C. for 30 to 120 seconds and then heat-treated in a heat-stretching zone between 210° C. and 260° C. In the normalization zone, the heat-stretched PA6.6 cords were cooled down to room temperature. The total extension in the pretreatment was 1.2%.

For all PA6.6 cords, the process steps of the drying in the drying zone and of the heat treatment were executed as known to the skilled person. The temperature in the drying zone or in the normalization zone was not varied in all the above experiments. The temperature exerted on the PA6.6 polyamide cords in the heat-stretching zone, by contrast, was adjusted such that the properties, for example tensile strength, elongation at break and shrinkage at 180° C. of the cord, were not adversely affected.

The total extension in the pretreatment is the sum of the individual stretches in the drying zone, heat-stretching zone or normalization zone.

Production of the Test Specimens for the Disk Fatigue Test

The respective PA6.6 cords cooled down to room temperature, after being produced as described above, were rubberized with an unvulcanized standard rubberization mixture. The rubberization is effected by placing the cords onto or between calendered thin rubber sheets of the rubberization mixture and then compressing the entire test specimen in a hot press.

Production of the Pneumatic Vehicle Tires

The heat-treated PA6.6 polyamide cords were rubberized with an unvulcanized standard rubberization mixture and then processed further in a manner known to those skilled in the art with the tire components that were still required to give a pneumatic vehicle tire. The resulting pneumatic vehicle tires were then tested for their tire uniformity as described above in the corresponding test method.

Results:

The test results of the study of inventive and noninventive polyamide cords having different total extensions and having the same linear yarn densities in the pretreatment are shown in table 1 below:

TABLE 1
Experimental data of the polyamide cords produced in accordance
with the invention and not in accordance with the invention and test
results of the industrial rubber particles produced with the polyamide
cords (test specimens and pneumatic vehicle tires).

| | | Comp. | | | | |
|---|---|---|---|---|---|---|
| | | exp. V1 | Exp. E1 | Exp. E2 | Exp. E3 | Exp. E4 |
| Property | Unit | Non-inv. | Inv. | Inv. | Inv. | Inv. |
| Production of the | | | | | | |
| polyamide cord | | | | | | |
| Total extension in | % | 7 | 1.2 | 1.2 | 1.2 | 1.2 |
| the pretreatment | | | | | | |
| | | Comp. | | | | |
| Property | Unit | exp. V1 | Exp. E1 | Exp. E2 | Exp. E3 | Exp. E4 |
| Polyamide cord | | | | | | |
| Production material | — | PA6.6 | PA6.6 | PA6.6 | PA6.6 | PA6.6 |
| Linear yarn density | dtex | 1400 | 1400 | 1400 | 1400 | 1400 |
| Number of yarns | — | 2 | 2 | 2 | 2 | 2 |
| Total linear density | dtex | 2800 | 2800 | 2800 | 2800 | 2800 |
| Yarn twist | tpm | 290 | 300 | 350 | 370 | 390 |
| Twist factor | — | 153 | 159 | 185 | 196 | 206 |
| Elongation at break | % | 21 | 24 | 25 | 24 | 26 |
| Tensile strength | N | 227 | 228 | 224 | 223 | 221 |
| Shrinkage at 180° C. | % | 4.8 | 3.4 | 3.6 | 3.9 | 3.7 |
| Residual shrinkage | % | 2.3 | 0.9 | 0.9 | 1.1 | 0.9 |
| Test specimen | | | | | | |
| Disk fatigue test | % | 100 | 113 | 111 | 109 | 111 |
| (relative values*) | | | | | | |
| Max. el.: 9.9% | | | | | | |
| Min el.: 5.1% | | | | | | |
| Pneumatic vehicle | | | | | | |
| tire | | | | | | |
| Number of radial | — | — | — | — | 2 | — |
| carcasses | | | | | | |
| Tire uniformity (“1st | mm | not | not | not | 0.18 | not |
| harmonic”)** | | tested | tested | tested | | tested |

*The value measured for comp. exp. V1 in table 1 was normalized to 100% and the improvement in the values for the polyamide cords of the invention was reported by comparison with the normalized value for comp. exp. V1.
**What was measured was the deviation between the ascertained geometric center of the circumferential shape of the pneumatic vehicle tire produced and the axis of rotation of the wheel on which the pneumatic vehicle tire was mounted in the measurement (see test method “Tire uniformity”).

It can be inferred from table 1 that a decrease in total extension in the pretreatment from 7% to 1.2% can achieve a significant decrease in residual shrinkage and shrinkage at 180° C. As a result, it is possible to achieve not only better results in the disk fatigue test but also pneumatic vehicle tires having elevated uniformity (see the last three lines in table 1). More particularly, the results for the pneumatic vehicle tire with a polyamide cord of the invention having a twist factor of 196 show that the above-described production method can produce pneumatic vehicle tires having exceptional tire uniformity (cf. 0.18 mm, last line in table 1).

Moreover, the proportion of pneumatic vehicle tires produced that has an above-described deviation of less than 1.25 mm was well above 90% (measurement results not indicated in table 1).

The test results from the study of polyamide cords of the invention with equal total extension in the pretreatment and different linear yarn densities are shown in table 2 below:

TABLE 2
Experimental data of the polyamide cords of the invention with different twist
factors and test results of the industrial rubber articles produced with the
polyamide cords of the invention (test specimens and pneumatic vehicle tires).

| | | Exp. E1 | Exp. E2 | Exp. E3 | Exp. E4 | Exp. E5 |
|---|---|---|---|---|---|---|
| Property | Unit | Inv. | Inv. | Inv. | Inv. | Inv. |
| Production of the | | | | | | |
| polyamide cord | | | | | | |
| Total extension in | % | 1.2 | 1.2 | 1.2 | 1.2 | 1.2 |
| the pretreatment | | | | | | |
| Polyamide cord | | | | | | |
| Production material | — | PA6.6 | PA6.6 | PA6.6 | PA6.6 | PA6.6 |
| Linear yarn density | dtex | 1400 | 1400 | 1400 | 1400 | 1880 |
| Number of yarns | — | 2 | 2 | 2 | 2 | 2 |
| Total linear density | dtex | 2800 | 2800 | 2800 | 2800 | 3760 |
| Yarn twist | tpm | 300 | 350 | 370 | 390 | 335 |
| Twist factor | — | 159 | 185 | 196 | 206 | 205 |
| Elongation at break | % | 24 | 25 | 24 | 26 | 26 |
| Tensile strength | N | 228 | 224 | 223 | 221 | 285 |
| | Unit | Exp. E1 | Exp. E2 | Exp. E3 | Exp. E4 | Exp. E5 |
| Shrinkage at 180° C. | % | 3.4 | 3.6 | 3.9 | 3.7 | 3.8 |
| Residual shrinkage | % | 0.9 | 0.9 | 1.1 | 0.9 | 0.9 |
| Test specimen | | | | | | |
| Disk fatigue test | % | not | 100 | 136 | 146 | 141 |
| (relative values*) | | measured | | | | |
| Max. el.: 13.5% | | | | | | |
| Min el.: 1.4% | | | | | | |
| Pneumatic vehicle | | | | | | |
| tire | | | | | | |
| Number of radial | — | — | — | 2 | — | — |
| carcasses | | | | | | |
| Tire uniformity | mm | not tested | not | 0.18 | not | not |
| (“1st harmonic”)** | | | tested | | tested | tested |

*The value measured for exp. E2 in table 2 was normalized to 100% and the improvement in the values for the remaining polyamide cords of the invention in table 2 was reported by comparison with the normalized value for exp. E2.
**What was measured was the deviation between the ascertained geometric center of the circumferential shape of the pneumatic vehicle tire produced and the axis of rotation of the wheel on which the pneumatic vehicle tire was mounted in the measurement (see test method “Tire uniformity”).

It can be inferred from table 2 that an increase in the twist factor with establishment of the new production parameters of a production method of the invention can achieve a significant improvement in the results in the disk fatigue test and in tire uniformity (see last three lines in table 2). The test conditions in the disk fatigue test with which the results were ascertained in table 2, as already elucidated above, differ in that the conditions were more aggressive (maximum elongation was 13.5% and minimum elongation was 1.4%) than the test conditions in the disk fatigue test with which the results in table 1 were ascertained. The test conditions as used for the determination of the measurements in table 2 simulate the real demands on a polyamide cord when used in a pneumatic agricultural tire better than the test conditions in the disk fatigue test with which the results in table 1 were ascertained. It can therefore be concluded from the measurement results from the disk fatigue test in table 2 that polyamide cords of the invention having a twist factor in the range from 190 to 210 are more advantageous for pneumatic tires that are used in vehicles with heavy loads, especially in pneumatic agricultural tires. The comparison is made here with polyamide cords having a twist factor below 190.

The total extension in the pretreatment in all examples in table 2 was 1.2% In the pneumatic vehicle tire produced, a deviation of the ascertained geometric center of the tread contour of the motor vehicle tire produced of less than 1.25 mm from the center of the bead circle of the radial first harmonic was measured.

Moreover, the proportion of pneumatic vehicle tires produced that has an above-described deviation of less than 1.25 mm was well above 90% (measurement results not indicated in table 2).

1.-11. (canceled)

12. A polyamide cord for use as carcass strength member in a pneumatic vehicle tire, wherein the polyamide cord has a residual shrinkage in the range from 0% to 2% and a shrinkage at 180° C. in the range from 0% to 4.5%, and wherein the residual shrinkage of the polyamide cord and the shrinkage at 180° C. of the polyamide cord are determined to ASTM D 855.

13. The polyamide cord as claimed in claim 12, wherein the polyamide cord has a total linear density in the range from 940 dtex to 6000 dtex, and consists of two, three, four or more than four twisted multifilament yarns, where each of the multifilament yarns has a linear yarn density in the range from 1000 dtex to 3000 dtex.

14. The polyamide cord as claimed in claim 12, wherein the polyamide cord has a twist factor in the range from 170 to 250.

15. The polyamide cord as claimed in claim 12, wherein the polyamide cord has a total linear density of 2800 dtex, wherein the polyamide cord consists of two twisted multifilament yarns, each of the multifilament yarns having a linear yarn density of 1400, wherein the polyamide cord has a twist factor in the range from 190 to 210, wherein the polyamide cord has a residual shrinkage of 1.1%, wherein the polyamide cord has a shrinkage at 180° C. of 3.9%, and wherein the polyamide cord consists of PA6.6.

16. The polyamide cord as claimed in claim 12, wherein the polyamide cord has a total linear density of 3760 dtex, wherein the polyamide cord consists of two twisted multifilament yarns, each of the multifilament yarns having a linear yarn density of 1880, wherein the polyamide cord has a twist factor of 190 to 210, wherein the polyamide cord has a residual shrinkage of 0.9%, wherein the polyamide cord has a shrinkage at 180° C. of 3.8%, and wherein the polyamide cord consists of PA6.6.

17. The polyamide cord as claimed in claim 12, wherein the polyamide cord has a residual shrinkage in a range from 0.5% to 2%.

18. The polyamide cord as claimed in claim 17, wherein the polyamide cord has a residual shrinkage in a range from 0.8% to 2%.

19. The polyamide cord as claimed in claim 18, wherein the polyamide cord has a residual shrinkage in a range from 0.9% to 1.1%.

20. The polyamide cord as claimed in claim 12, wherein the polyamide cord has a shrinkage at 180° C. in a range from 0.5% to 4.5%.

21. The polyamide cord as claimed in claim 12, wherein the polyamide cord has a shrinkage at 180° C. in a range from 1% to 4.5%.

22. The polyamide cord as claimed in claim 12, wherein the polyamide cord has a shrinkage at 180° C. in a range from 3% to 4%.

23. The polyamide cord as claimed in claim 14, wherein the polyamide cord has a twist factor in the range from 170 to 230.

24. The polyamide cord as claimed in claim 23, wherein the polyamide cord has a twist factor in the range from 190 to 210.

25. The polyamide cord as claimed in claim 24, wherein the polyamide cord has a twist factor in the range from 200 to 210.

26. A pneumatic vehicle tire comprising one or more polyamide cords as claim in claim 12.

27. The pneumatic vehicle tire as claimed in claim 26, wherein the pneumatic vehicle tire is a pneumatic agricultural tire.

28. The pneumatic vehicle tire as claimed in claim 26, wherein the pneumatic vehicle tire comprises a radial carcass having 1 to 6 carcass plies.

29. A process for producing one or more polyamide cords, wherein the process comprises at least the following process steps in the following sequence:
a. dipping one or more textile strength members into at least one dip bath containing at least one latex;
b. then heat treating the one or more dipped strength members within a temperature range from 120 to 260° C. and simultaneously stretching the one or more strength members such that, over the entire process, the one or more strength members have been subjected to a total extension in the range from 0% to 6%;
c. further processing the one or more heat-treated strength members so as to give one or more polyamide cords.

30. The process for producing one or more polyamide cords as claimed in claim 29, further comprising:
d. rubberizing the one or more polyamide cords with a rubberization mixture and further processing so as to form a rubberized reinforcement ply.

31. The process for producing one or more polyamide cords as claimed in claim 30, further comprising:
e. incorporating the rubberized reinforcement ply into a tire blank and further processing the tire blank to give a pneumatic vehicle tire.
